(19) United States
(12) Patent Application Publication
(10) Pub. No.: US 2012/0254062 A1
(43) Pub. Date: Oct. 4, 2012

(54) Index Based on Temporally Staggered Value Samples

(75) Inventors: John Labsuzewski, Westmont, IL (US); Candice Graham, Chicago, IL (US); Brenda Tucker, Chicago, IL (US); Jack Cook, Lombard, IL (US)

(73) Assignee: Chicago Mercantile Exchange Inc., Chicago, IL (US)

(21) Appl. No.: 13/079,443

(22) Filed: Apr. 4, 2011

(51) Int. Cl. G06Q 40/00

(52) U.S. Cl. 705/36 R

(57) ABSTRACT

Weights may be applied to temporally staggered value samples associated with a market item. Based on the weighted temporally staggered values, a value for an index is calculated. The calculated index value can then be output and used for any of a variety of purposes.

### BACKGROUND

Values for many items traded in a market can exhibit a seasonal behavior. Such items can include, but are not limited to, commodities and financial instruments (e.g., futures contracts and options) associated with such commodities. Several illustrations of commodities for which seasonality can be quite pronounced are in the context of agricultural and energy commodities. In particular, seasonal effects can result in substantial rise and fall of prices for such commodities throughout a calendar year.

Grains are but one example of an agricultural commodity for which prices often show seasonal effects. Because of anxieties over the coming summer growing season, prices for grain (e.g., corn and soybeans) tend to rise during the period from February to June. Often, however, such anxieties diminish once the crop is put into the ground and begins to sprout. Soybean prices often tend to decline during the summer months unless there are significant weather related issues such as floods or drought conditions. Grain prices tend to bottom out during harvest season centered around October

Lean hogs are another example of an agricultural commodity for which prices can display seasonal tendencies. Often, hog inventories may decline from late February into early summer as packers make significant purchases in anticipation of the summer grilling season. As a result, prices may rise during this period.

Gasoline is an example of an energy commodity for which prices often exhibit seasonal behavior. Prices for gasoline often rally during the period from February through May due to buildup of supplies in anticipation of the summer driving season. Prices for gasoline often fall over the winter months. Other types of energy commodities (e.g., home heating oil) may exhibit different seasonal behavior.

Although values for the above and many other types of goods may often rise and fall according to seasonal patterns, such seasonal patterns are by no means certain. Instead, seasonal patterns reflect broad tendencies for prices to rise and fall at certain times. These rises and falls will not always occur, and the amount of seasonal price variation may not be predictable with any precision. As a result, seasonal effects can introduce substantial uncertainty in the market and expose market participants to substantial financial risk.

### SUMMARY

This Summary is provided to introduce a selection of concepts in a simplified form that are further described below in the Detailed Description. This Summary is not intended to identify key or essential features of the invention.

In at least some embodiments, data identifying a market item having a potentially time variable value is received (e.g., by a computer). Data indicative of temporally staggered value samples associated with the market item is also received. Weights may then be applied to the temporally staggered value samples. Based on the weighted temporally staggered values, a value for an index is calculated. Data indicating the calculated index value can then be output and used for any of a variety of purposes. Such purposes can include settling of a futures contract based on that index value.

### BRIEF DESCRIPTION OF THE DRAWINGS

Some embodiments are illustrated by way of example, and not by way of limitation, in the figures of the accompanying drawings and in which like reference numerals refer to similar elements.

FIG. 1 shows a computer network system that may be used to implement aspects of the invention.

FIG. 2 shows a system for generating an index according to some embodiments.

FIG. 3 illustrates a method according to some embodiments for generating an index using temporally staggered value samples.

FIG. 4 illustrates a method according to some embodiments for utilizing an index generated using temporally staggered value samples.

### DETAILED DESCRIPTION

Embodiments of the present invention may take physical form in certain parts and steps, examples of which will be described in detail in the following description and illustrated in the accompanying drawings that form a part hereof.

### Exemplary Operating Environment

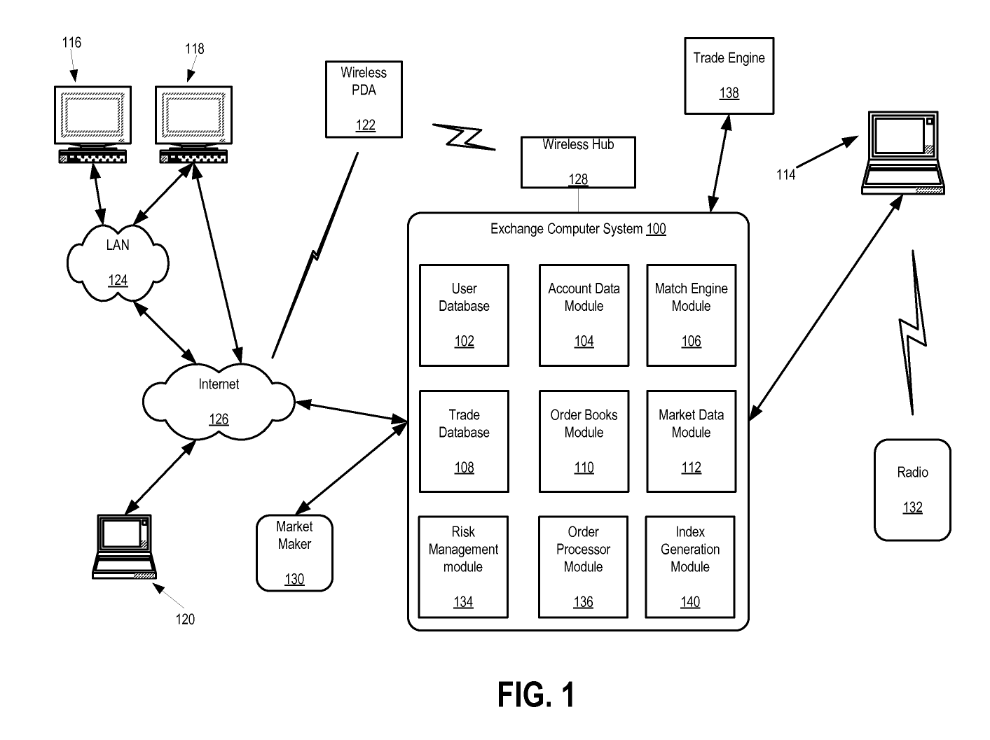

Aspects of at least some embodiments can be implemented with computer devices and computer networks that allow users to exchange trading information. An exemplary trading network environment for implementing trading systems and methods, including systems and methods that construct and/or utilize indexes calculated based on temporally staggered value samples, is shown in FIG. 1.

An exchange computer system 100 receives orders and transmits market data related to orders and trades to users. Exchange computer system 100 may be implemented with one or more mainframe, desktop or other computers. In one embodiment, a computer device uses a 64-bit processor. A user database 102 includes information identifying traders and other users of exchange computer system 100. Data may include user names and passwords. An account data module 104 may process account information that may be used during trades. A match engine module 106 is included to match bid and offer prices. Match engine module 106 may be implemented with software that executes one or more algorithms for matching bids and offers. A trade database 108 may be included to store information identifying trades and descriptions of trades. In particular, a trade database may store information identifying the time that a trade took place and the contract price. An order book module 110 may be included to compute or otherwise determine current bid and offer prices. A market data module 112 may be included to collect market data and prepare the data for transmission to users. A risk management module 134 may be included to compute and determine a user's risk utilization in relation to the user's defined risk thresholds. An order processing module 136 may be included to decompose delta based and bulk order types for processing by order book module 110 and match engine module 106. An index generation module 140 may be included within exchange computer system 100 for generation of one or more indexes based on temporally staggered value samples. Generation of such indexes is discussed below.

The trading network environment shown in FIG. 1 includes computer devices 114, 116, 118, 120 and 122. Each computer device includes a central processor that controls the overall operation of the computer and a system bus that connects the central processor to one or more conventional components, such as a network card or modem. Each computer device may also include a variety of interface units and drives for reading and writing data or files. Depending on the type of computer device, a user can interact with the computer with a keyboard, pointing device, microphone, pen device or other input device.

Computer device 114 is shown directly connected to exchange computer system 100. Exchange computer system 100 and computer device 114 may be connected via a T1 line, a common local area network (LAN) or other mechanism for connecting computer devices. Computer device 114 is shown connected to a radio 132. The user of radio 132 may be a trader or exchange employee. The radio user may transmit orders or other information to a user of computer device 114. The user of computer device 114 may then transmit the trade or other information to exchange computer system 100.

Computer devices 116 and 118 are coupled to a LAN 124. LAN 124 may have one or more of the well-known LAN topologies and may use a variety of different protocols, such as Ethernet. Computers 116 and 118 may communicate with each other and other computers and devices connected to LAN 124. Computers and other devices may be connected to LAN 124 via twisted pair wires, coaxial cable, fiber optics or other media. Alternatively, a wireless personal digital assistant device (PDA) 122 may communicate with LAN 124 or the Internet 126 via radio waves. PDA 122 may also communicate with exchange computer system 100 via a conventional wireless hub 128. As used herein, a PDA includes mobile telephones and other wireless devices that communicate with a network via radio waves.

FIG. 1 also shows LAN 124 connected to the Internet 126. LAN 124 may include a router to connect LAN 124 to the Internet 126. Computer device 120 is shown connected directly to the Internet 126. The connection may be via a modem, DSL line, satellite dish or any other device for connecting a computer device to the Internet.

One or more market makers 130 may maintain a market by providing constant bid and offer prices for a derivative or security to exchange computer system 100. Exchange computer system 100 may also exchange information with other trade engines, such as trade engine 138. One skilled in the art will appreciate that numerous additional computers and systems may be coupled to exchange computer system 100. Such computers and systems may include clearing, regulatory and fee systems.

The operations of computer devices and systems shown in FIG. 1 may be controlled by computer-executable instructions stored on a non-transitory computer-readable medium. For example, computer device 116 may include computer-executable instructions for receiving order information from a user and transmitting that order information to exchange computer system 100. In another example, computer device 118 may include computer-executable instructions for receiving market data from exchange computer system 100 and displaying that information to a user.

Of course, numerous additional servers, computers, handheld devices, personal digital assistants, telephones and other devices may also be connected to exchange computer system 100. Moreover, one skilled in the art will appreciate that the topology shown in FIG. 1 is merely an example and that the components shown in FIG. 1 may be connected by numerous alternative topologies.

### Exemplary Embodiments

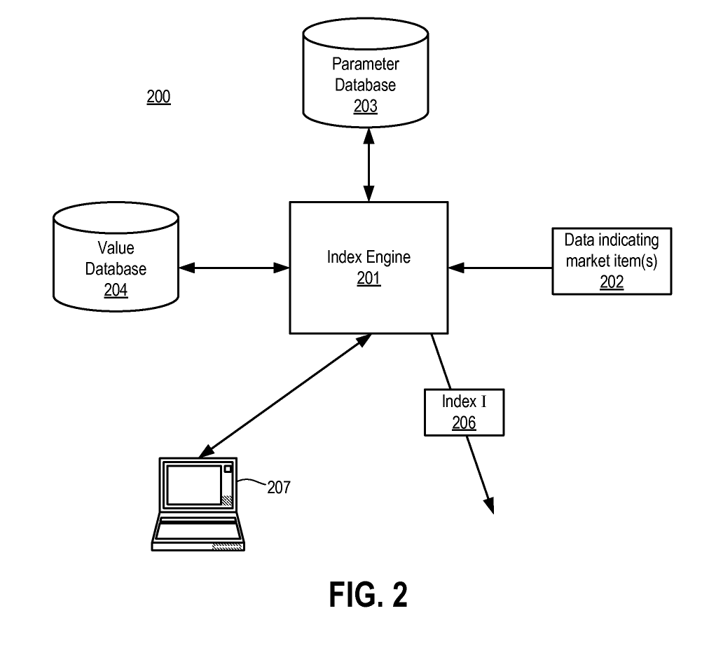

FIG. 2 is a block diagram of a system 200, according to some embodiments, that is configured to generate an index based on temporally staggered samples of values for one or more market items. System 200 can be implemented as (or as part of) index generation module 140 (FIG. 1), may be implemented as a standalone system, or may be implemented as part of another system. Index engine 201, which may be implemented in the form of one or more microprocessors executing program instructions, receives input 202 that includes data identifying one or more market item items for which an index is to be generated. A market item can be a commodity for which futures contracts, options and other instruments are traded on one or more commercial exchanges and/or for which there is otherwise a commercial market. A market item could be an agricultural commodity (e.g., one or more types of grain or oilseed products, one or more types of livestock products, one or more types of dairy products, one or more types of forest products, one or more types of soft products (e.g., cocoa, coffee)), an energy commodity (e.g., a crude oil product, a natural gas product, an ethanol product, an electricity product, a refined product, a coal product), a metal commodity (e.g., a precious, base, ferrous or other type of metal product), or some other type of commodity or tangible property. A market item could also (or alternatively) correspond to an intangible property interest (e.g., a currency, a futures contract or option, a credit default swap or other derivative).

Input 202 may be received in real time or near-real time. For example, input 202 may result from a user providing input into a graphical user interface displayed a computer. Input 202 may alternately be received as a result of accessing data previously stored in a database, or may be received as a result of other types of operations.

Index engine 201 interfaces with one or more value databases 204. Databases 204 store data that reflects values of commodities, commodities contracts, and/or other market items at various times throughout a preceding temporal period. Database 204 may be implemented as a distributed database residing in one or more of the modules of exchange computer system 100 (FIG. 1), may be implemented as a one or more software routines configured to extract data from one or more of said modules, may be implemented as a standalone database accessible over the Internet or other wide area network, or may be implemented in other ways.

Index engine 201 also interfaces with an index parameter database 203. Parameter database 203 stores information regarding value sampling periods, value sampling times and value sample weights, which information is used by engine 201 when calculating an index. The roles of value samples and value sample weights in the generation of an index are discussed in further detail below. Information in parameter database 203 can include, but is not limited to, one or more of the following: weights to be applied to samples, algorithms for calculating weights, sampling periods, times for obtaining value samples during a sampling period, algorithms for identifying sample times, etc. As with value database 204, parameter database 203 can be implemented in various ways.

Index engine 201 may also receive other types of input via one or more computers 207. For example, a human user of computer 207 may provide input to index engine 201 that configures index engine 201 to generate an index for a particular type of good. Such configuration can include specification of a sampling period, specification of times to obtain samples during that period, specification of weights to be applied to value samples, input of (or modification to) an algorithm to be used for determining weights and/or sampling times, designation of the source of data from which sample values should be obtained (e.g., designation of database 204), etc. Input regarding weights, sampling times, algorithms, data source, etc. may be stored by engine 201 in parameter database 203. Input 202 could also be provided via computer 207. Computer 207 may be the same computer on which engine 201 executes and/or may also house one or more of databases 203 and 204. Alternatively, any or all of engine 201, database 203 and database 204 could execute or reside on computers separate from computer 207, with computer 207 communicating with those separate computers over one or more local and/or wide area networks.

Index engine 201 provides an output 206 that includes data indicating a calculated index value (I). Output 206 can be used by additional engines or processes, as is described in more detail below.

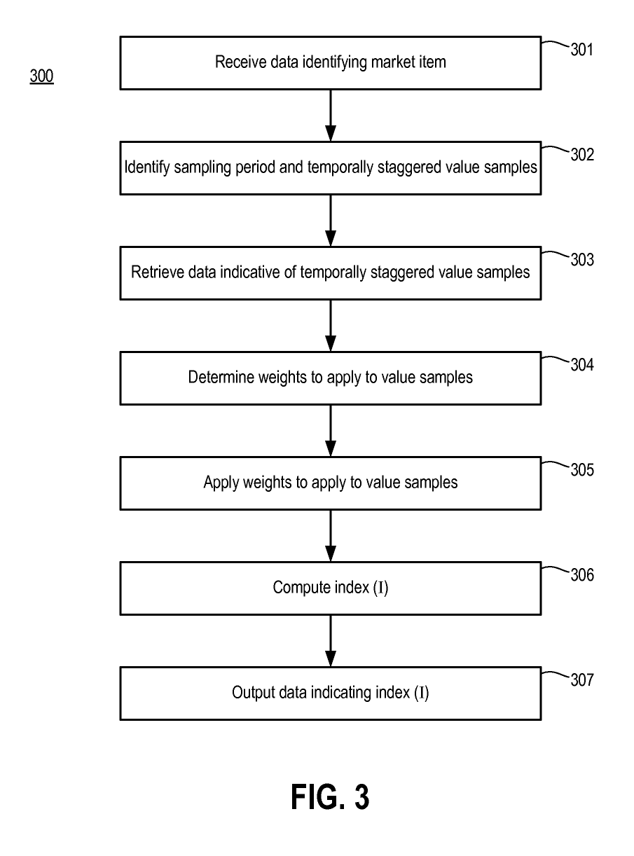

FIG. 3 is a flow chart showing operations in a method 300 that can be performed by index engine 201 according to some embodiments. FIG. 3 will be described using an example of hypothetical values for corn futures contract prices. However, this is solely for purposes of illustration and is no way intended as a limitation on the type of commodities, goods or market items for which indexes may be calculated according to various embodiments.

In step 301, engine 201 receives input 202 that contains data identifying one or more market items. In the present example, and as indicated above, input 202 contains data indicating that an index for corn futures contract prices is to be calculated. In other embodiments, however, input 202 can contain data indicating another market item.

In step 302, engine 201 identifies a sample period. Engine 201 also identifies multiple temporally staggered sample points during that period at which values for the index subject are to be sampled. The index subject may be the market item identified in step 301 or some other market item (e.g., a futures or option contract) that is based on or otherwise associated with that previously-identified market item. In step 303 engine 201 then retrieves data indicating values for those identified sample points over the identified sample period.

The sampling period and the sample points can be identified in any of a variety of ways. In some embodiments, sampling points can be based on times that are generally recognized in a particular industry or market segment as having significance. In the present example, corn futures contracts typically designate delivery during the months of March, May, July, September and December. Furthermore, the United States Department of Agriculture officially defines the corn crop year as beginning on September 1. However, Midwestern U.S. corn crops are typically harvested in October. Thus, December-delivery contracts could be regarded as the beginning of a crop year for practical purposes. Accordingly, an index for corn futures prices can be based on a one year sample period corresponding to the December, March, May, July and September contracts in a one year period. Sample values could then be selected that correspond to each of the contract delivery months. Notably, trading in corn futures contracts designating delivery in a particular month typically terminates on the business day prior to the 15th day of the preceding month. For some period of time prior to trading termination for a particular month's contracts (e.g., the 5th through the 9th days of the preceding month), contracts for that month may roll forward to the next contractual delivery month. Accordingly, engine 201 in the current example retrieves data indicating sample values taken at the 5th of the month prior to each delivery month, as set forth in Table 1.

TABLE 1

| 5th Business Day of | Sampled Price (S) |
|---|---|
| November (December contracts) | $3.92 |
| February (March contracts) | $3.75 |
| April (May contracts) | $4.21½ |
| June (July contracts) | $3.50 |
| August (September contracts) | $3.05 |

Each of the sampled prices in Table 1 could itself be calculated in any of a variety of ways. As one example, each of the sample values in Table 1 could be an average of closing prices for all corn futures contracts having a delivery date in the month at issue. Those closing prices could be recorded as of the 5th day of the month preceding the delivery month of those contracts. Thus, the sample for November 5 ($3.92) could be an average of the closing prices on November 5 of all corn futures contracts that designate delivery in the following month (December).

Other techniques could be used for calculating a sample value. As a further example, a subset of all December corn futures contract closing prices on November 5 could averaged (e.g., contracts designating delivery in certain locations). As yet another example, the value for each sample could be a value of a separate index (e.g., the S&P GSCI corn index value) calculated for the commodity in question on the sampling date.

In step 304, engine 201 determines a weight to apply to each sample for which data was retrieved in step 303. In the current example, engine 201 assigns an equal weight to each sample. This weight (0.20 in the present example) can be calculated by 1/N, where N is equal to the number of samples. Table 2 is similar to Table 1, but includes the weights (W) for each sample.

TABLE 2

| 5th Business Day of | Sampled Price (S) | Weight (W) |
|---|---|---|
| November (December contracts) | $3.92 | 0.20 |
| February (March contracts) | $3.75 | 0.20 |
| April (May contracts) | $4.21½ | 0.20 |
| June (July contracts) | $3.50 | 0.20 |
| August (September contracts) | $3.05 | 0.20 |

In other embodiments, certain sample values may have greater significance and may thus be assigned a greater weight. For example, each sample could be weighted by trading volume at the time of sampling. As but one sub-example of such a technique, each weight could be calculated according to equation 1.

Wᵢ=Vᵢ/(V₁+V₂+ . . . +V_{N}), Equation 1:

where
i=1 for November, 2 for February, . . . 5 for August, and
Vᵢ=the trading volume, on the 5th day of the i^{th} month, of corn futures contracts serving as the basis for the i^{th} month sampling value.

After determining weights in step 304, engine 201 applies those weights to the sample values in step 305. In the embodiment of FIG. 3, engine 201 applies those weights by multiplying each sample by its corresponding weight. In step 306, engine 201 then computes the index value I. In some embodiments, index I is calculated by summing the products of each sample and its corresponding weight. In the present example, that index (I) is the sum of 0.2*(3.92)+0.2*($3.75)+0.2*($4.215)+0.2($3.50)+0.2*($3.05), or $3.687.

After calculating index I in step 306, engine 201 outputs data indicating I at step 307. I can then be used in a variety of ways. As but one example of a manner in which I could be used, a corn futures contract could specify that the contract will be cash or financially settled by reference to the index. This could be useful to investors or commercial market participants who, for example, are focused on values prevailing during a particular season but wish to mute the impact of seasonality during the course of that season.

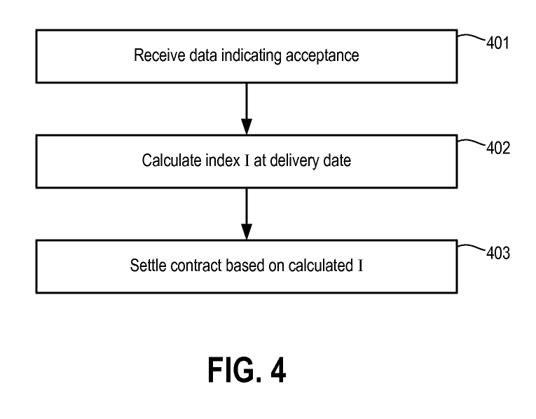

FIG. 4 is a flow chart showing steps that may be performed in connection with a futures contract or other instrument that is to be settled by reference to temporally-staggered value sample index. In particular, FIG. 4 illustrates settling a contract utilizing a value for index I calculated in accordance with FIG. 3. The steps shown in FIG. 4 could be performed in the system of FIG. 1 as operations resulting from execution of computer-readable instructions. Beginning in step 401, exchange computer system 100 receives data indicating acceptance of an offer (or bid) for a futures contract or other instrument that specifies settlement based on the value of a temporally-staggered value sample index to be calculated at a delivery date or other later date. At that later date, and as shown in step 402, a value for index I is calculated by engine 201. In step 403, the value for index I output from engine 201 is provided as a data input to one or more modules of exchange computer system 100. Settlement of the contract is then performed based on index I (e.g., by communication of additional data among modules of system 100 to reflect payment of the settlement).

As previously indicated, embodiments include numerous variations on the techniques described thus far. Sampling times and/or the number of samples and/or the sampling period could be varied. As but one further example, an index could be calculated based on samples corresponding to values over several years. Thus, instead of calculating an index based on value samples obtained at times throughout one year, an index could be calculated based on value samples obtained at times throughout multiple years. This approach could be useful, e.g., to mute the effects of an anomaly that does not typically occur every year (e.g., a severe weather event that affects a particular crop, a political event that affects a particular energy or metal commodity, etc.).

Sample weights could also be determined in numerous other ways. For, example, certain months in a year might be historically significant because of weather or other events during those periods that may have a substantial impact on prices. Thus, weights for samples corresponding to those months could be increased so as to reflect that historical significance, with other weights reduced accordingly. As another example, weights for samples that are close in time to significant production periods (e.g., when most of a season's harvest will have been finished) could be increased and the weights of samples corresponding to later delivery dates can be decreased.

Some weight determination techniques could also (or alternatively) be used to further mute the effect of historically rare events. In some embodiments, a weight determination algorithm could examine whether a sample value on a particular date is statistically anomalous. For example, a sample value might exceed other sample values in the same period by more than a predesignated percentage, by more than a predesignated percentage of a standard deviation of all the sample values in the period, or by some other statistically relevant measurement. If a sample value is statistically anomalous, the weight for that sample could be reduced based on an assumption that an abnormally large value increase has resulted from a condition that is unlikely to be repeated during the same sampling period. The algorithm might further include one or more additional flags that must be set before a weight is reduced based on a statistically anomalous value. As a further example, a weight determination algorithm for an agricultural commodity index could have a flag that is set if an especially severe flooding or drought event has occurred during the sampling period. If the flag is set and a statistically anomalous sample occurs, the weight for that sample can be decreased. If a statistically anomalous sample occurs and the flag is not set, however, the weight might not be reduced.

Indexes could also be based on temporally staggered value samples for more than one type of commodity. In some embodiments, for example, an index could be calculated based on samples of values for separate commodities that are related in some manner. In such cases, sampling periods for the different commodities need not be identical.

The foregoing description of embodiments has been presented for purposes of illustration and description. The foregoing description is not intended to be exhaustive or to limit embodiments to the precise form explicitly described or mentioned herein. Modifications and variations are possible in light of the above teachings or may be acquired from practice of various embodiments. The embodiments discussed herein were chosen and described in order to explain the principles and the nature of various embodiments and their practical application to enable one skilled in the art to make and use these and other embodiments with various modifications as are suited to the particular use contemplated. Any and all permutations of features from above-described embodiments are the within the scope of the invention.

1. A method comprising:
receiving, by a computer, data identifying a market item having a potentially time variable value;
receiving, by a computer, data indicative of temporally staggered value samples associated with the market item;
applying, by a processor, weights to the temporally staggered value samples;
calculating, by a processor, an index value based on the weighted temporally staggered values; and
outputting data indicating the calculated index.

2. The method of claim 1, wherein the market item is an exchange-traded commodity.

3. The method of claim 2, wherein the market item is an agricultural commodity.

4. The method of claim 2, wherein the market item is an energy commodity.

5. The method of claim 2, wherein the market item is a metals commodity.

6. The method of claim 1, wherein applying weights to the temporally staggered value samples comprises applying different weights to at least a portion of the value samples.

7. The method of claim 6, wherein applying weights to the temporally staggered value samples comprises applying weights based on trading volume associated with the market item.

8. The method of claim 6, wherein applying weights to the temporally staggered value samples comprises applying at least one weight that has been reduced in response to a statistically anomalous sample value.

9. The method of claim 1, wherein each of at least some of the temporally staggered value samples corresponds to a delivery date associated with the market item.

10. The method of claim 1, wherein at least one of the temporally staggered value samples corresponds to a production date associated with the market item.

11. The method of claim 1, further comprising:
receiving the output data indicating the calculated index at a computer system module; and
settling a contract associated with the market item based on the calculated index.

12. A non-transitory computer-readable medium storing computer executable instructions that, when executed, cause the computer to perform operations that include:
receiving, by a computer, data identifying a market item having a potentially time variable value;
receiving data indicative of temporally staggered value samples associated with the market item;
applying weights to the temporally staggered value samples;
calculating an index value based on the weighted temporally staggered values; and
outputting data indicating the calculated index.

13. The computer-readable medium of claim 12, wherein the market item is an exchange-traded commodity.

14. The computer-readable medium of claim 13, wherein the market item is an agricultural commodity.

15. The computer-readable medium of claim 13, wherein the market item is an energy commodity.

16. The computer-readable medium of claim 13, wherein the market item is a metals commodity.

17. The computer-readable medium of claim 12, wherein applying weights to the temporally staggered value samples comprises applying different weights to at least a portion of the value samples.

18. The computer-readable medium of claim 17, wherein applying weights to the temporally staggered value samples comprises applying weights based on trading volume associated with the market item.

19. The computer-readable medium of claim 17, wherein applying weights to the temporally staggered value samples comprises applying at least one weight that has been reduced in response to a statistically anomalous sample value.

20. The computer-readable medium of claim 12, wherein each of at least some of the temporally staggered value samples corresponds to a delivery date associated with the market item.

21. The computer-readable medium of claim 12, wherein at least one of the temporally staggered value samples corresponds to a production date associated with the market item.

22. The computer-readable medium of claim 12, storing further computer executable instructions that, when executed, cause the computer to perform operations that include:
receiving the output data indicating the calculated index at a computer system module; and
settling a contract associated with the market item based on the calculated index.
